(19) United States
(12) Patent Application Publication
(10) Pub. No.: US 2006/0044111 A1
(43) Pub. Date: Mar. 2, 2006

(54) Real-time data reporting using radio frequency identification

(75) Inventors: Thomas Kollar, CINNAMINSON, NJ (US); Carol Bozarth, Maple Shade, NJ (US); Edward A Mulka, Mt Laurel, NJ (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: JAFA Technologies., Inc.,, Mt. Laurel, NJ (US)

(21) Appl. No.: 10/505,533

(22) PCT Filed: Feb. 24, 2003
(86) PCT No.: PCT/US03/05632

§ 371 Date: Jul. 29, 2005

Related U.S. Application Data
(60) Provisional application No. 60/358,694, filed on Feb. 22, 2002.

(51) Int. Cl. G06F 17/30; G08B 13/14

(52) U.S. Cl. 340/10.1; 340/572.1; 705/22; 705/28; 235/385

(57) ABSTRACT

A system for tracking and reporting data using RFID technology includes an article and a radio frequency identification tag attached to the article. The tag has an identifier associating the tag with the article and containing data representative of information about the article. A reader senses the presence of the identification tag and reads the identifier information and the data. An operations computer is in communication with the reader for receiving from the reader, in real time, the identifier information and the data, recording the identifier information and the data, and generating output data regarding the article. At least one workstation remote from the operations computer an in communication with the operations computer is able to access the output data generated by the operations computer.

### RELATED APPLICATION

The present application claims priority from U.S. Provisional Application Ser. No. 60/358,694, filed 22 Feb. 2002.

### FIELD OF THE INVENTION

The field of the invention is reporting data regarding sales of RFID tagged merchandise. The merchandise is sold at one or more locations and data regarding the sales at the locations is available to a remote computer user.

### BACKGROUND OF THE INVENTION

In the entertainment industry, accurate and timely reporting of data is critical to success. A spike in music sales requires increased production of related CDs, an increase in advertising and marketing expenditures, and distribution of more CDs to radio stations. Localized sales spikes are met with the same solutions and, further, inventory of CDs may be shifted from one location to another to fulfill the localized interest in a CD. If the sales increases are inaccurately reported, the advertising, marketing, and production costs are wasted. The success of DVDs, movie tickets, and events like concerts depends on accurate reporting.

It currently takes about a week for data gathered from sales at the point of sale in a store, box office, or over the Internet to be reported accurately. Gathering and processing the data is a time consuming process. To reduce this time, entertainment companies project sales based on limited returns. These projections are prone to error and unreliable. Projections rely on a small sampling of data points (sales in certain stores), but ignore the entire data set, that is, all sales in all stores in every geographic location. However, the time it takes to gather all the sales data is such that, as a practical matter, heretofore projections were all that companies could rely on.

A need exists for real time reporting and tracking in the retail entertainment and movie-ticket industries. The present invention satisfies that need

### SUMMARY OF THE INVENTION

In its broad aspects, the invention is a system for tracking and reporting data using radio frequency identification (RFID) technology comprising: an entertainment industry article; a radio frequency identification tag attached to the article, the tag having an identifier associating the tag with the article and containing data representative of information about the article; a reader that senses the presence of the identification tag and reads said identifier information and said data; an operations computer in communication with the reader for receiving in real time from the reader said identifier information and said data, recording said identifier information and said data, and generating output data regarding the article; and at least one workstation remote from the operations computer and in communication with the operations computer enabled to access the output data generated by the operations computer.

The RFID tags can be attached to or embedded in a compact disc, a digital versatile disc, a video cassette recorder tape, a memory stick, a CompactFlash card, a Secure Digital card, a ticket, a smartcard, a laser disc, packaging for a compact disc, packaging for a digital versatile disc, packaging for a video cassette recorder tape, packaging for a memory stick, packaging for a CompactFlash card, packaging for a Secure Digital card, packaging for a ticket, packaging for a smartcard, or packaging for a laser disc. The tags are used to track and gather data on sales and use of the item tagged. A reader/antenna senses the RFID tag at the counter or checkin/out area, and the sale data (based on the tag's presence) is transmitted to a database for processing and reporting.

The database and output can be remotely accessed using nearly any type of modern computer with Internet access. Thus, at the remote location, no specialized equipment need be installed. The core of the system comprises an RFID tag, a reader/antenna, an operations computer or server, and remote workstations connected to the operations server.

### BRIEF DESCRIPTION OF THE DRAWINGS

FIG. 1 is a diagram showing a first embodiment of the invention adapted for use in a retail sales environment.

FIG. 2 shows the RFID tag attached to a CD jewel case.

FIG. 3 is a diagram showing a second embodiment of the invention adapted for use in ticketed entertainment.

FIG. 4 shows the RFID Smart Card and ticket for use in the ticketed entertainment setting.

### DESCRIPTION OF THE INVENTION

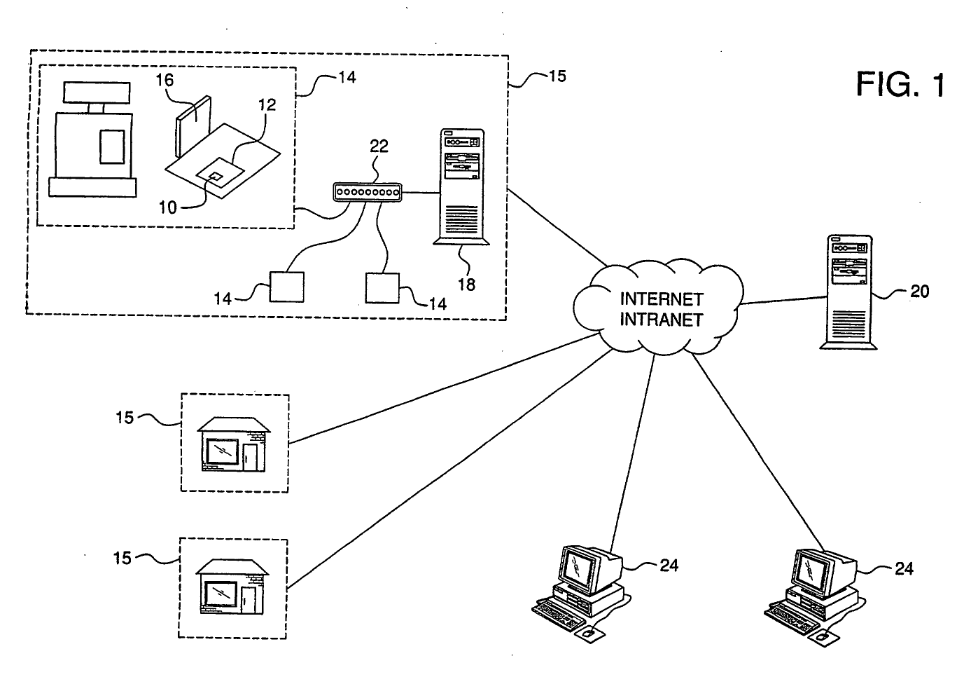

FIG. 1 shows a first embodiment of the invention adapted for use in the retail entertainment sales environment. In the preferred embodiment, the invention incorporates radio frequency identification (RFID). Some industries use RFID systems to track items. Such systems include EZ-PASS, which tracks vehicles passing through toll stations, smartcard applications where funds are credited and debited to an electronic purse, animal tagging and tracking, proximity magnetic keys to gain access to locked doors, theft prevention of retail merchandise, and warehouse inventory tracking.

RFID systems usually employ three components: 1) an antenna or coil, 2) a transceiver (with decoder), and 3) a transponder (also known as an RF tag) electronically programmed with unique information. The antenna emits radio signals to activate the tag and read and/or write data to it, and is the link between the tag and the transceiver. The transceiver controls the RFID system's data acquisition and communication. The electromagnetic field produced by an antenna can be present continuously when multiple tags are expected continually (such as in the EZ-PASS example), or if a continuous presence is not required, the RF tag can activate the field when it comes within a certain proximity to the antenna.

Often, the antenna is packaged with the transceiver and decoder to comprise a reader or interrogator, which can be configured as either a handheld or a fixed-mount device. The reader emits radio waves in ranges of anywhere from one inch to 100 feet or more, depending upon its power output and the radio frequency used. When an RFID tag passes within range of the emitted radio waves, the tag is activated and emits a signal representative of data stored in the tag. The reader receives that signal and decodes the data; and the data are transmitted to a host computer for processing.

The data tracking system of the present invention comprises a point of sale (POS) 14 such as that typically found in a retail store location 15. POS 14 has an RFID antenna/reader 16 arranged to detect and read (and possibly write) data from a transponder in the form of a radio frequency (RF) tag 10 attached to the article for sale 12. The article 12 may be a compact disc, a digital versatile disc, a video cassette recorder tape, a memory stick, a CompactFlash card, a Secure Digital card, a ticket, a smartcard, a laser disc and the like.

Multiple readers 16, located at multiple points of sale 14 within a retail store location 15 are connected to a hub 22, by means of which each reader 16 is connected to a local computer/server 18. The readers 16 transmit the RF tag data to the local server 18 via a wired or wireless network. From the local server 18, the data are transmitted to the operations computer/server 20 either instantly, at predetermined intervals, or manually. Information from other locations 15 having one or more POS 14 is also transmitted to the operations server 20. In this way, sales data for all stores connected to the operations server 20 are gathered on a near real time basis.

The operations server 20 records, analyzes, and processes the sales data (and perhaps related data) and reports the processed data to system users. A person physically at the location of the operations server 20 could access the processed sales data (and related output) directly. More common, however, is the situation shown in FIG. 1 in which a user accesses the sales data and reports from an external workstation 24 that connects to the operations server 20 via an Internet, Intranet, or other connection.

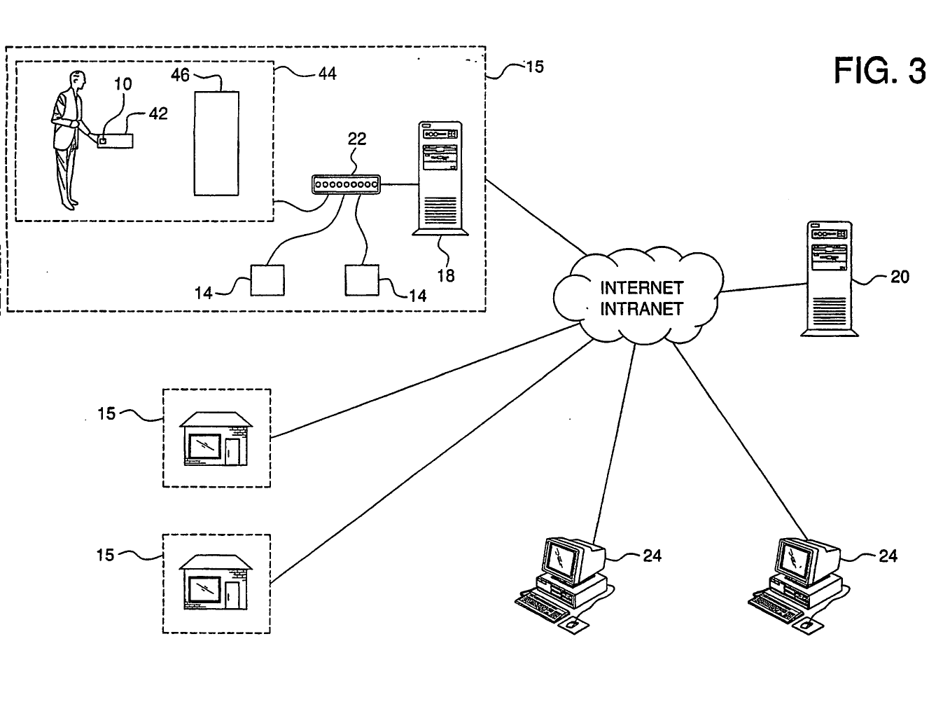

In the second embodiment shown in FIGS. 3 and 4, the tag 10 is embedded into or attached to a ticket or smart card 42. The ticket or smart card tag 10 gives its holder access to an event like a concert or movie.

In use at a movie multiplex, for example, the ticket holder walks past a sensor located near the door to the theater within the multiplex showing the movie. The system reads and compares the tagged ticket 40 with the movie playing in the theater. If the two are the same, the ticket holder is admitted to the theater. If the two do not match, an alarm might be activated to alert theater staff to a problem (for example, a person entering a movie he did not pay for). Further, if a person tried to enter the theater without a ticket, a sensor would sound to again call theater personnel to investigate.

In this way, the ticket 42 with the RF tag 10 thereon that a person purchased could be used to enter only the movie selected at the ticket counter. This would prevent children from attending movies with mature ratings and prevent unauthorized entry into movies.

Another advantage of this system is that it would provide the same tracking and reporting capabilities as the tag attached to the CD. As a person enters the theater, a reader 46 near the door recognizes the ticket and transmits the data to a local server 18 that in turn transmits it to a operations server 20. Just like the previous example of the CD sales, the operations server 20 is accessible by external workstations 24 connected to the operations computer 20 via an Internet, Intranet, or other connection.

A smartcard 43 could also be employed to track movie entry. The card's tag is activated prior to entry into an event or theater and when the user passes the reader 46, a check is made of the card. If the card is preauthorized to view the movie, the card would be “debited” one movie or event entrance. In this way, a smart card could be prepurchased and used several times before it would become useless. Alternatively, it could be “recharged” so that its holder could use the card to gain access to other movies and events in the future.

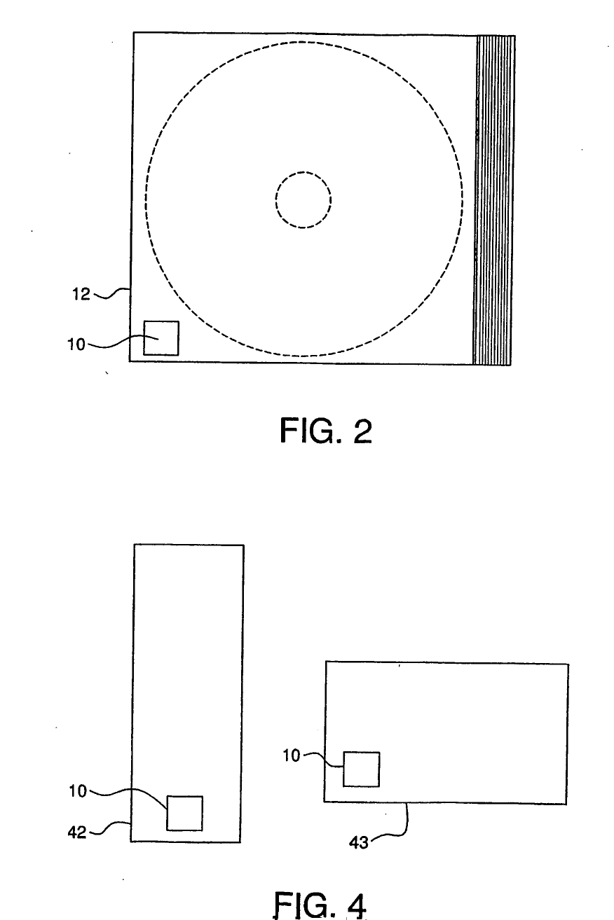

For the embodiment shown in FIGS. 1 and 2, a person or machine may affix the RFID tag 10 to the CD, DVD, or tape case 12. The tag 10 shown is approximately postage stamp sized. Other shapes and sizes are possible and may be necessitated based on where the tag 10 is located. For instance, digital movies and music can be stored on memory sticks, CompactFlash cards, and Secure Digital Cards. Those storage media are generally currently sold as read/write media, but in the future read-only versions of the media may be available that store songs or movies. The cases that contain the media could be so small that postage stamp sized RFID tags would block writing or pictures on the case (for example, a Secure Digital Card is postage stamp sized). For the majority of media, however, a postage stamp sized RFID tag 10 is adequate.

The RFID tag 10 is inlaid in a thin polymer substrate with an adhesive applied on one face of the substrate. The tags 10 generally come in a roll and have a protective surface covering the adhesive face. Application of the tag 10 requires removing the tag from the strip and pressing the tag's adhesive surface to the merchandise. This can be done manually or by a machine.

Tags 10 can be active or passive. An internal battery powers active tags. Such tags are typically read/write tags (data can be written to and retrieved from the tags). The use of a battery means that a sealed active transponder has a finite lifetime. However, a suitable cell coupled to suitable low power circuitry can ensure functionality for as long as ten or more years, depending upon the operating temperatures, read/write cycles and usage. The trade-off is greater size and greater cost compared with passive tags. In general terms, active transponders allow greater communication range than can be expected for passive devices, better noise immunity, and higher data transmission rates when used to power a higher frequency response mode.

For the read/write active tag, the UPC code information is written into the tag. When the tag 10 is read by the reader 16, the tag data is transferred to the local server 18 and the reader 16 writes data to the indicating that the tagged good is now “sold.” This read/write application is more expensive than its passive tag read-only counterpart.

Passive tags operate without an internal battery source, deriving the power to operate from the field generated by the reader. Passive tags are consequently much lighter than active tags, less expensive, and offer a virtually unlimited operational lifetime. The trade-off is that they have shorter read ranges than active tags and require a higher-powered reader. Passive tags are also constrained in their capacity to store data and the ability to perform well in electromagnetically noisy environments. Sensitivity and orientation performance may also be constrained by the limitation on available power. Despite these constraints, passive transponders offer advantages in terms of cost and longevity. They have an almost indefinite lifetime and are generally less expensive than active transponders.

The passive read only tags would have a tag serial number associated with a specific UPC code in a database at the local or operations server. When the tag data is read, the serial number is flagged in the server so it cannot be entered a second time, the appropriate UPC is identified, and external reports accessible on the operations server are updated.

Available types of reader/antenna 16 and 46 differ in complexity, depending upon the type of tags being supported and the functions being performed. The reader's function is to provide the means of communicating with the tags and facilitating data transfer. Once the reader 16 reads and receives the signal from a tag 10, algorithms may be applied to decide whether the signal is a repeat transmission, and the reader may then instruct the transponder to cease transmitting. This is known as the “Command Response Protocol” and is used to circumvent the problem of reading multiple tags in a short space of time. This is particularly helpful in the retail data setting where the goal is to count the item purchased once only.

Data communication between tags 10 and a readers 16 is by wireless communication. Two methods of communication distinguish RFID systems, one based upon close proximity electromagnetic or inductive coupling and one based upon propagating electromagnetic waves. Coupling is via antenna structures that form an integral feature in both tags and readers. While the term antenna is generally considered more appropriate for propagating systems, it is also loosely applied to inductive systems.

The reader 16 may be capable of simultaneous identification. Simultaneous identification allows the reader to count multiple tags immediately upon the tags entering the range of the reader 16. This obviates the need for a cashier to “scan” each item individually. Such readers are known.

When a customer purchases a product that has a tag 10 thereon, a cashier or other store employee at the POS 14 insures that the reader 16 recognizes each tagged item. When the reader/antenna reads each tag, it may emit an audible tone so the cashier knows the tagged item has been recorded. Grocery store laser UPC readers verify readings similarly: as each product is scanned, the register emits a tone.

For security purposes; additional readers 16 may also be located near exits from a store. These readers 16 read the RFID tag 10 and compare them with the tags recently read at the POS 14. If there is a match (i.e., the tagged item was paid for), no action is taken. If there is no match, the system concludes that the tag 10 was not scanned at the POS 14 and the item was not paid for, and an alarm would sound, calling the store's attention to a possible theft. Thus, a passive RFID 10 tag could be used both to track merchandise and prevent theft.

Within either the local server 18 or the operations server 20, the data from the readers is stored, analyzed, and reported. As contemplated herein, it is generally assumed that the operations server stores, analyzes and reports the data. The types of output that can be generated include:
total number of tagged items sold number of tagged items sold by store
number of tagged items sold compared with other geographical areas, stores, or points of sale
number of tagged items sold by artist, producer, company, etc.
number of tagged items sold within different timeframes or compared to other timeframes
comparisons between inventories of tagged items versus those items sold (for purposes of shifting inventory between locations 15)
custom ad hoc reports

Output from the operations server could be made available via a web server (not shown) and updated at some regular interval, or made available at the moment a user requests it. Previously, to get such reports based on reliable (non-projected) data required at least one week's lead time. With the system of the invention, such reports are available based on more timely (up to the minute) sales data.

The remote workstation 24 is a computer connected to the operations server 20 via, most conveniently, the Internet. However, other connection methods may be used. The remote workstation 24 would not need any special hardware, and if the operations server output is made available over the Internet, the workstation 24 should not need any special software beyond a web browser. The output from the operations server 20 would be accessible to a person with the correct authorization, such as a pre-assigned password.

The availability of the data on the operations computer 20 to someone logging in from a workstation 24 will depend on the user's permission to access the data. A senior executive might have access to all of the generated reports, while more junior employees might have access to only certain of the reports. Similarly, the computer staff in charge of the database might have both access to the reports and an ability to manipulate the data remotely. A permission hierarchy should be set up before any user accesses the data.

The data tracking system described herein provides real or near real time tracking capabilities for tracking sales in the entertainment industry. Unreliable projections are unnecessary, and decision making executives do not have to “guess” at what the sales will be when they make decisions about advertising, marketing, and inventory management. The executives can make their decisions based on data that reflects up to the minute sales.

We claim:

1. A data tracking system comprising:
a) an entertainment industry article;
b) a radio frequency identification tag attached to the article, the tag having an identifier associating the tag with the article and containing data representative of information about the article;
c) a reader that senses the presence of the identification tag and reads said identifier information and said data;
d) an operations computer in communication with the reader for receiving in near real time from the reader said identifier information and said data, recording said identifier information and said data, and generating output data regarding the article; and
e) at least one workstation remote from the operations computer and in communication with the operations computer enabled to access the output data generated by the operations computer.

2. The data tracking system of claim 1 wherein the article is selected from the group consisting of a compact disc, a digital versatile disc, a video cassette recorder tape, a memory stick, a CompactFlash card, a Secure Digital card, a ticket, a smartcard, a laser disc, packaging for a compact disc, packaging for a digital versatile disc, packaging for a video cassette recorder tape, packaging for a memory stick, packaging for a CompactFlash card, packaging for a Secure Digital card, packaging for a ticket, packaging for a smartcard, and packaging for a laser disc.

3. The data tracking system of claim 1 wherein the operations computer and the workstation communicate via the Internet.

4. The data tracking system of claim 1 wherein the output data includes total number of tagged articles sold.

5. The data tracking system of claim 1 wherein the reader is located at a first geographic location, the operations computer is located at a second geographic location, and the workstation is located at a third geographic location.

6. The tracking system of claim 5 wherein a second reader reads the tag identifier information as the tag passes through a boundary of the first geographic location and compares the tag identifier information with the tag identifier information read at the first reader to prevent unauthorized removal of the article from the first geographic location.

7. The data tracking system of claim 1 wherein the reader, tag, and article are located at a first geographic location, and further comprising:
a) a second entertainment industry article at a second geographic location remote from the first geographic location;
b) a second radio frequency identification tag attached to the second article, the second tag having a second identifier associating the second tag with the second article and containing data representative of information about the second article;
c) a second reader at the second geographic location in communication with the operations computer; and
d) wherein the operations computer receives from the second reader said second identifier information and said data, records said second identifier information and said data, and generates output data regarding the article and second article.

8. The data tracking system of claim 7 wherein the output data includes number of tagged articles sold by geographic location.

9. The tracking system of claim 1 wherein the tag is an active tag.

10. The tracking system of claim 1 wherein the tag is a passive tag.

11. The tracking system of claim 1 wherein the operations computer is in communication with the reader via the Internet.

12. The tracking system of claim 1 wherein the operations computer is in communication with the reader through a local computer.

13. The tracking system of claim 1 wherein the operations computer is in communication with the workstation via a web server.
